(19) United States
(12) Patent Application Publication
(10) Pub. No.: US 2023/0167023 A1
(43) Pub. Date: Jun. 1, 2023

(54) BI- OR MULTICOMPONENT FIBRES FOR LARGE COMPOSITE PARTS

(71) Applicant: ETH Zurich, Zurich (CH)

(72) Inventors: Christoph SCHNEEBERGER, Zofingen (CH); Nicole Barbara AEGERTER, Chur (CH); Joanna Chi-Hing WONG, Calgary AB (CA); Shelly Anne ARREGUIN, Bern (CH); Paolo Angelo P. ERMANNI, Zürich (CH)

(73) Assignee: ETH Zurich, Zurich (CH)

(21) Appl. No.: 17/922,211

(22) PCT Filed: Apr. 23, 2021
(86) PCT No.: PCT/EP2021/060638

§ 371 Date: Oct. 28, 2022

(30) Foreign Application Priority Data
Apr. 29, 2020 (EP) 20172137.0

(51) Int. Cl. C03C 25/20; B29C 70/20; C03C 25/325; C03C 25/285; C03B 37/02

(52) U.S. Cl. CPC C03C 25/20; B29C 70/20; C03C 25/325; C03C 25/285; C03B 37/02; B29K 2033/12

(57) ABSTRACT

Bi— or multicomponent fibre (3) comprising a reinforcing core (1) of a first material and at least one sheath (2) of a second, thermoplastic or pre-polymerized thermoset material, for the manufacturing of composite parts, the matrix of which composite parts consists of the material of said sheath (2), wherein said first material has a degradation temperature, ignition temperature, glass transition temperature, melting temperature or liquidus temperature which is higher than the melting temperature, flowing temperature, r softening temperature of said second, thermoplastic or pre-polymerized thermoset material, wherein said reinforcing core (1) has a core volume fraction (v_{f}) defined as the volume fraction of the reinforcing core (1) in the bi- or multicomponent fibre (3), which is in the range of 0.3-0.8, and wherein along a longitudinal axis (Z) of the bi- or multicomponent fibre outer surface (4) of the sheath (2) has a corrugated, preferably irregular corrugated shape.

### TECHNICAL FIELD

The present invention relates to bi- or multicomponent fibres in particular for producing large composite parts, preforms based on such fibres, methods for producing such fibres, composite parts based on such fibres or preforms, as well as uses of such fibres for making composite parts and the like.

### PRIOR ART

Fibre-reinforced polymer composites are a well-established solution for industries relying on high structural performance combined with low weight. However, high-volume production remains a challenge and many markets still have to rely on cheaper, but less efficient materials, while others are restricted in their material choice and have to accept the use of slow production methods. This issue becomes even more pronounced for manufacturers of large components, for example: in the production of pipes, tanks, silos, boat hulls or other boat parts, fuselage or wing components for aircrafts, rocket fairings, turbine blades including wind turbine blades etc.

Typically large parts in this field are parts which are too oversized to be processed in a hydraulic press (>2 m in any dimension), but also including anything that cannot be processed in an autoclave due to size restrictions (>10-40 m in any dimension). For example, today's wind turbine rotor designs feature blades of 50 meters length and more, with offshore turbine blades having crossed the 100 meter mark. Conventional metal-based designs do not provide the required performance, so composites have become the standard in this industry. Nevertheless, high-volume production is still an issue because fast composite processes are primarily based on press technology and the use of thermoplastic polymers, whereas today's blades are only manufactured using time-intensive thermoset resin infiltration and curing. Because of their long design lifetimes of 20-30 years, structural fatigue is a major concern in wind blades and the material performance limits both structural efficiency and achievable component size.

Furthermore, most designs can only be realized through the fabrication of multiple parts which are then bonded using adhesives or joined using mechanical fasteners like bolts or rivets. This adds more weight to the structure and creates weak regions with increased potential for structural failure due to fatigue.

With ever more wind turbines being erected, the disposal of old turbines is also becoming a growing issue. Upon reaching their end of life, thermoset composites become waste and can only be incinerated or deposited in landfills.

Currently, composite components can only be manufactured with thermoplastic matrix polymers by using presses or autoclaves, because available intermediate materials can only be properly consolidated with higher than atmospheric pressure. Large components therefore require considerable equipment investments and largest parts with lengths above ca. 40 m cannot be made from thermoplastic matrix composites at all. This imposes significant limitations on the exploitation of thermoplastic composites, which carry beneficial properties for both the design and the production of large structures. The state-of-the-art in producing (wind) turbine blades or composite boat hulls or other large composite parts from the energy infrastructure, aerospace or marine field, but also from the field of industrial plant infrastructure parts, is vacuum bagging bare fibre textiles combined with a thermoset resin infiltration step followed by curing and often also by post-curing/tempering. However, for applications with highest demands on mechanical performance, more expensive processing routes are still needed, e.g. the processing of fibre textiles pre-impregnated with thermoplastic or thermoset matrix materials (prepregs) in an autoclave, or the use of expensive out-of-autoclave (OOA) prepregs (thermoset materials only).

JP-A-2011162905 provides a fiber material for reinforcing a molding material, exhibiting improved dispersibility/mixability and a high reinforcement effect upon blending it with a hydraulic material such as mortar and concrete, or with various molding materials such as a resin and rubber. There is disclosed a resin-impregnated fiber bundle made to have an uneven surface, including a fiber material (A) selected from an organic fiber and an inorganic fiber integrally impregnated with a thermoplastic resin (B), which resin-impregnated fiber bundle is to be used as a fiber material for reinforcing a molding material. The molding material is selected from a hydraulic material, a synthetic resin, a natural resin, synthetic rubber, natural rubber, and a ceramic material.

EP-A-2481558 relates to a device for manufacturing at least one preimpregnated preform of a plurality of dry semi-finished products or dry fabrics impregnated with resin said device comprising at least one first vacuum chamber, and a flexible vacuum foil tightening said at least one first vacuum chamber, said at least one preform being encompassed by said first vacuum chamber and said vacuum foil. At least one second vacuum chamber is provided and said vacuum foil is separating said at least one first vacuum chamber from said second vacuum chamber. Said at least one first vacuum chamber is liquid tight. The present invention relates as well to a method for manufacturing at least one preimpregnated preform with such a device and a product resulting from said method.

### SUMMARY OF THE INVENTION

The presented invention provides the unique solution to all of the above mentioned challenges, in particular the cost-efficient production of large and very large thermoplastic or thermoset composite parts of high mechanical quality at high volume without investing in presses, autoclaves, or expensive OOA prepregs through a novel innovative material architecture with a cost-effective and scalable manufacturing route.

The invention comprises hybrid bi- and/or multicomponent fibres (BCF and/or MCF) with an irregular outer envelope, a method to manufacture such fibres, as well as their use in a vacuum bagging process for the fabrication of a composite structure.

These fibres comprise at least a stiff and strong reinforcing core fibre and a thermoplastic (including thermoplastic elastomers) or pre-polymerized thermoset sheath, the latter forming the outermost part of the fibre. Pre-polymerized thermoset refers to thermoset (polymer) materials, which are not yet fully cured and/or polymerized and may still be processed as fluids at elevated temperatures, while able to maintain their essential shape at room temperature.

The core may consist of an organic material (polymer) or inorganic material (ceramic, glass, basalt, carbon) which can be fiberized using conventional spinning methods (e.g. melt-spinning, wet-spinning, gap-spinning) or the precursor to which can be fiberized in the same method. There can also be a mixture of core fibres e.g. carbon and glass, so mixing of different types of hybrid fibres is also included. The sheath may consist of any thermoplastic or pre-polymerized thermoset material with a lower melting point, softening temperature, flow temperature (or glass transition temperature), or liquidus temperature than the core (preferably all of these temperatures, if present, are lower than the ones of the core), in particular and preferably, the sheath is an amorphous or semi-crystalline thermoplastic polymer. The solid sheath may be non-porous or foamed, with an open or closed cell porous structure. Furthermore, the fibres may contain one or more intermediate layers of additional material between core and sheath for the purposes of modifying the mechanical performance of the core-sheath interface or for functionalization, e.g. to render the fibre electrically conductive, magnetic, or to enhance structural damping properties. The core is normally cylindrical with an arbitrary cross-sectional shape, in particular a circular or close to circular shape. However the core fibre may also have a non-circular cross-section, it can therefore also be a flat fibre, for example with rectangular cross-section, oval cross-section or cocoon shaped cross-section. Furthermore, the core may also be a hollow fibre (e.g. H-glass). The core may have any width, typically below 20 μm. The cross-sectional shape of the sheath is arbitrary. The thickness or width of the sheath varies along the length of the fibre. This variation can be of any shape and it may be periodic or irregular. The core may be fully covered by the sheath or may exhibit bare sections with zero sheath thickness. On average, the sheath may make up 20% to 70% of the total volume of the fibre (excluding air and other gases from the total volume).

More generally speaking, the present invention relates to the following subject matter: proposed is a bi- or multicomponent fibre comprising a reinforcing core of a first material (or a mixture of first materials) and at least one sheath of a second, thermoplastic or pre-polymerized thermoset material, suitable and adapted for the manufacturing of composite parts, the matrix of which composite parts consists of the material of said sheath. The idea behind the fibre is that the volume of the sheath is sufficient to allow for generating composite parts essentially without air inclusions based on the proposed fibres, in which the matrix is formed by the sheath material, and the reinforcement fibres provided by the core are embedded in that matrix.

To this end, said reinforcing core has a core volume fraction defined as the volume fraction of the reinforcing core in the bi- or multicomponent fibre, which is in the range of 0.3-0.8, preferably in the range of 0.5-0.7. The volume fraction as defined here is what is termed Faservolumengehalt FVG according to DIN 16459. If the core of the fibre is a hollow fiber core, the void interior space of the core is counted as part of the volume fraction of the reinforcing core.

The minimum mean amount of coating in the outermost sheath of the bi- or multicomponent fibres is equal to the volume not occupied by the remainder of the fibres when imagined in closest packing. In particular, for any given application with a desired volume content of the core material(s) of the fibres, the mean amount of coating in the outermost sheath is equal to the remaining volume content: if v_{f} is the desired volume fraction of the core material(s) in the final consolidated material and vₛ is the volume fraction of the outermost sheath within the fibres prior to consolidation, then it follows that vₛ=1−v_{f}. Typical values for v_{f} range from 0.3 to 0.8. In particular, typical values for v_{f} in high-performance structural applications range from 0.5 to 0.7.

This is a concept completely different from the one of the prior art mentioned above, JP-A-2011162905: In this document JP-A-2011162905 the fibre is not to be used without a matrix, i.e. it is not a fibre where the actual matrix of the final part is provided exclusively by the coating of the fibres. The fibre of JP-A-2011162905 is expressly to be used with a matrix which is called “molding material” and which is selected from a hydraulic material, a synthetic resin, a natural resin, synthetic rubber, natural rubber, and a ceramic material. In JP-A-2011162905 the fibres, or rather the fibre bundles of D1, are proposed to be mixed with such a matrix, and specifically in [0044] the proportion of the fibres should not be higher than 50 mass parts compared with 100 mass parts of cement. Thus there always must be a matrix in addition to the coating of the fibre, and the proportion of this matrix is very significant. The coating of JP-A-2011162905 is thus much thinner than what is claimed, so the core volume fraction is significantly higher than 0.8, the claimed upper limit value. Further, looking at the actual aim of JP-A-2011162905, there is no motivation go for a small core volume fraction below 0.9 for the uses contemplated in JP-A-2011162905.

Further for the specific use in a vacuum forming process if the core volume fraction is above 0.8, there will not be sufficient matrix material to actually form a really useful fibre reinforced material, because there will be remaining voids. So for the purposes of what is aimed for in JP-A-2011162905 there is no point in having a thick sheath, and thus the skilled person understands from JP-A-2011162905 to have a core volume fraction well above 0.9.

For this type of hybrid fibre material as presented here, where the coating shall provide the full amount of material for the matrix of the final composite, the core volume ratio needs to be at most 0.8, as higher fractions of fibre cores of a cylindrical or close to cylindrical geometry lead to dense or densest packings with voids impairing the properties of the final part. For fully cylindrical fibre cores of equal diameter, the densest packing, a triangular packing, is calculated to occupy a volume fraction of 0.91, meaning that any higher volume fraction by definition requires additional matrix material to fill the space between the core material. However, practical applications further reserve the possibility of the fibres to be laid up in different orientations, meaning that a layer of fibres oriented in one direction may be covered by another layer oriented in another, second direction. This arrangement does not allow for triangular packing, but maximally for square packing as the densest configuration, for which the maximum volume fraction is easily calculated to at most 0.8. To allow for such arrangements of the fibres without leaving empty space, the core volume of the bi- or multi-component fibre thus needs to be at most 0.8. According to the proposed invention, said first material (core material(s)) has/have a (onset of) degradation temperature, ignition temperature, glass transition temperature, melting temperature or liquidus temperature (preferably any one, a combination or or all of these in as far as present in the first material), which is higher than the melting temperature of said second, outermost thermoplastic or pre-polymerized thermoset material (in case of pre-polymerized thermoset material the melting temperature is often rather a softening temperature or flow temperature). Preferably all of these temperatures of said second material are lower than any of said temperatures of the first material. The importance of this feature is that the first material (core material) or mixture thereof does not lose its mechanical, in particular elastic properties, when the second material (sheath material) melts or softens upon a rise in temperature and becomes processable.

Furthermore, and importantly, along a longitudinal axis of the bi- or multicomponent fibre, the outer surface of the sheath has a corrugated shape. The corrugation can be regular or irregular. Due to the production processes used, normally this corrugated shape is however irregular. When these packing fibres already carry the future matrix material in the form of a sheath they can be further processed to generate a composite part using evacuation and heating. The corrugated outer shape along the longitudinal axis of the fibres promotes high transverse permeability needed for evacuation by providing channels between the fibres being packed close to parallel. When using such fibres with a non-corrugated surface, in a direction essentially perpendicular to the longitudinal direction, so in a transverse direction, there is a dense packing without or with hardly any air permeability and channels. The proposed corrugations generate interspaces between the packed fibres, thereby forming air channels in a transverse direction, and thus dramatically facilitates the withdrawal of the air out of the future composite part in any vacuum/heat consolidation process. The proposed corrugated fibres thus allow the making of much larger parts without air inclusions or essentially without air inclusions, thereby providing significantly higher mechanical stability of the final composite part.

The corrugation therefore has a characteristic allowing for the forming of such transverse air channels.

The main invention thus lies in the use of BCF/MCF with preferably variable sheath thickness to mould composite structures. So, the corrugation of the outer surface of the sheath can be due to a variable sheath thickness along the length of the fibre core, the latter having a constant diameter or more generally a constant cross-section along its axis. However, the corrugation can also be due to a corrugated core structure, and the layer thickness of the sheath can be constant along the length of the fibre. Also a combination of the two is possible.

The variability of the hybrid fibre width creates gaps between the fibres which create open porosity within the structure i.e. isotropically distributed air gaps: usually, fibre packings create gaps which run along the direction in which the fibres are oriented, but these irregular coatings create gaps in transverse fibre direction as well. This creates flow channels for deaeration in the thickness direction of the laminate while the vacuum is pulled. This is an essential feature for manufacturing large components, where full deaeration only through channels along the length of the fibres is impossible. Additionally, the presented invention ensures proper vacuum distribution and deaeration even for the thickest laminates. The gaps created by the morphology of the BCF/MCF need to be collapsed during consolidation, because voids deteriorate the final composite's mechanical strength and fatigue resistance. Therefore, a thermoplastic or pre-polymerized thermoset sheath is used, such that the gaps stay intact during deaeration, but collapse during consolidation. At the same time, this thermoplastic or pre-polymerized thermoset material becomes the matrix of the composite, i.e. the material, which binds the reinforcing fibres which carry the main mechanical loads of the structure. This innovation enables the manufacturing of large fibre-reinforced thermoplastic components that are otherwise unattainable from state-of-the-art consolidation processes for thermoplastic composite preforms, which require higher than atmospheric pressures. Therefore, the use of BCF/MCF preforms is the only method to manufacture large components without using giant autoclaves or building excessively expensive and technically complex presses. BCF/MCF are the only hybrid thermoplastic composite intermediate materials which can be fully consolidated under vacuum pressure, particularly using the vacuum bag method, and therefore realize a cost-efficient value chain for high-volume and large scale components.

The combination of BCF/MCF fibres or preforms and vacuum bagging represents the only processing chain allowing for the use of thermoplastic matrix materials to manufacture large scale composites virtually without limitations on size. This is only made possible by the microstructure of the fibres exhibiting a thickness/width variation of the outermost sheath along the fibre direction, which ensures proper deaeration throughout the entire part. Compared to conventional resin infiltration processes, this technology can cut the total mould occupancy time by 30% or more, because the time-intensive infiltration, curing, and post-curing/tempering processes are replaced by a single heating and cooling cycle. This massive reduction in cycle time is also an advantage over resin infiltration methods based on novel reactive thermoplastic resins. Additionally, BCF technology does not need to compromise on the design of the polymerization reaction for the sake of a more efficient manufacturing process, as reactive thermoplastic resins do. BCF/MCF technology therefore carries the potential to disrupt the market of large scale composite production. BCF/MCF may also be used in conventional press-based manufacturing processes for thermoplastic composites, where they provide a significant reduction in overall production costs. Today, efficient press processes, e.g. stamp forming, have to rely on expensive preconsolidated intermediate materials. Preconsolidation is used to impregnate dry fibrous preforms with the thermoplastic melt, which is a slow and therefore expensive process. This step can be performed by the supplier of the material or by the part producer itself, but there has been no way to avoid it thus far. BCF/MCF preforms can be stamp formed without any preconsolidation step and because of the method used to fabricate them, the entire value chain avoids a slow and expensive impregnation step, which significantly reduces the overall production costs.

E.g. the energy infrastructure, aircraft, ships and boats, industrial plant and technical infrastructure markets and in particular the wind turbine blade market can benefit significantly from the added customer value provided by the proposed BCF/MCF preform technology. Total blade production cost can be considerably reduced by cutting the mould occupancy time by an estimated 30%+ when switching from state-of-the-art resin infiltration to vacuum bagging of BCF/MCF. This enables cost savings by using fewer of the expensive moulds per production run of a given blade design and provides the potential to move offshore blade production down to 24 h mould cycles, which is not possible today. This will lead to more consistent product performance and fewer manufacturing faults due to every shift performing the same work as experts, rather than every worker needing to be trained for every part of the production process. The advancement in production efficiency provided by BCF enables an increased output of blades. In view of the current market development, this supports the use of sustainable wind energy in lieu of fossil fuels. The mould occupancy time can be reduced even further by replacing standard adhesive bonding technology to join the two halves of the blade shell and to join the shear webs to the spars by simply welding the thermoplastic composite material. Welding of thermoplastic composites is already established in the aerospace industry, providing a cost-effective joining solution, and is more structurally efficient, meaning that longer and thus more efficient blade designs can be realized. In comparison to thermoset resins, thermoplastics offer higher toughness and elongation at break, which carries the potential to mitigate issues of structural fatigue in the shell layers, where damage progressing between the reinforcing fibres is a central issue of the structural design (inter-fibre fracture). Improving the material performance here further advances the possibilities for more efficient blade designs. Additionally, material scraps resulting from trimming and boring actions after demoulding the blade could be re-used as core materials in another blade or sold for the production of short-fibre reinforced components in other markets. These proposed values will advance the state-of-the-art in energy infrastructure, aircraft, ships and boats, industrial plant and technical infrastructure, in particular wind turbine blade production and break the barriers of structural efficiency which are imposed on today's designs in favour of a more cost-efficient and sustainable energy source.

BCF/MCF preforms offer advantages in various conversion processes to produce complex composite structures. Similar advantages outlined for the wind energy market apply to the marine industry, where the manufacturing of boat hulls as large components can benefit from the use of welding methods to join thermoplastic composite laminates, which were previously manufactured using BCF/MCF with vacuum bagging and a thermal process cycle. The manufacturing of medium-sized components using fast conversion processes like rapid stamp forming in a press can benefit from BCF due to substantial reductions of material cost, as state-of-the-art preforms (consolidated blanks or so-called organosheets) used for these methods are highly expensive to produce. Additional benefits include the possibility to pre-fabricate three-dimensional near net shape preforms before moving to the press, taking advantage of the increased flexibility of BCF preforms at room temperature in comparison to existing market solutions. These benefits are advantageous for exploitation in the production of automotive body parts and of radomes or other antenna covers in the aerospace sector. The 3D printing industry benefits from the simple fact that BCF provide a hybrid intermediate material at the scale of single filaments. This opens possibilities for fused deposition modeling-type processes converting continuous fibre-reinforced thermoplastics to print structural prototypes at a high resolution or to print components of a much smaller size than currently possible.

The outer surface of the outermost sheath in the bi- or multicomponent fibre according to the invention has to exhibit a corrugation along the axial direction of the fibre. Said corrugation is comprised of areas, where the distance between the surface and the geometrical midpoint of the same corrugated cross-section is significantly higher than in other areas. Hereafter, the areas with comparatively longer distance between the surface and midpoint within the cross-section are referred to as peaks and the areas with comparatively shorter distance between the surface and midpoint within the cross-section are referred to as valleys. The aforementioned corrugation is characterized by such peaks and valleys and transitional areas in between, wherein the peaks and valleys can be irregular in width and/or height.

The various parameters and properties of concern here are defined in the present context as follows:

Ignition temperature: Defined as the lowest temperature at which combustion of a flammable substance can be initiated depending on the exposed temperature level and heat flux (flow of energy per unit area and time). The substance may also autonomously ignite without an external source of ignition. The autogenous ignition temperature of liquids and solids in a high-pressure oxygen-enriched environment can be determined by ASTM G72 for substances with ignition temperatures up to 500° C. For combustible materials the corresponding German norm is DIN 54836.

Degradation temperature: Temperature at which changes in chemical structure occur that affect (typically reduce) the material's performance e.g. reduced strength, ductility, color change, increased embrittlement. The degradation temperature can be determined by thermogravimetry e.g. according to ASTM E2550, or DIN EN ISO 11358-1 where the mass of the specimen decreases at elevated temperatures due to production of volatile products. Differential thermal analysis or differential scanning calorimetry may also be used to determine the degradation temperature. In this case physical changes will affect the characteristic glass transition or melting temperature.

Softening temperature: Temperature at which a material softens beyond some determined softness. The softening occurs through increased mobility of molecules, crystals or molecule chains within the material due to increased thermal energy within the material. For Polymers this temperature is determined by Vicat softening method (DIN EN ISO 306), heat deflection test (ASTM-D648) or ring or ball method (DIN EN 1238 for thermoplastic adhesives or DIN EN 1427 for Bitumen). In the example of the Vicat softening temperature, the Vicat Softening Temperature is defined as the temperature at which a flat-ended needle penetrates the specimen to a predefined depth under specified load using a selected uniform rate of temperature rise. For glasses the softening temperature is the point below which the glass behaves as solid and is measured by ASTM C338 through the temperature at which the specimen elongates by its own weight at a predefined rate. The corresponding ISO norm is DIN ISO 7884-6.

Liquidus temperature: Defined by ASTM C162 as the maximum temperature at which equilibrium exists between the molten glass and its primary crystalline phase. Mostly used for impure substances like alloys, glasses or minerals. ASTM C829 “Measurement of Liquidus Temperature of Glass by the Gradient Furnace Method”.

Glass transition temperature: For glass defined by DIN ISO 7884-8, for polymers defined by DIN EN ISO 11357-2.

Thermal properties (melting temperature, glass transition temperature) can be determined with reference to the ISO Standard 11357-1/-2/-3 on pellets.

More specifically, for amorphous and micro-crystalline materials, differential scanning calorimetry (DSC) can be carried out with a heating rate of 10K/min. Heating to temperature between extrapolated end temperature of glass transition (DSC, ISO 11357, heating rate 10 K/min) and the starting point of loss in mass (TGA, ISO 11358, heating rate 10 K/min).

Release of vacuum and demoulding after cooling below extrapolated onset temperature of glass transition (DSC, ISO 11357, cooling rate −10 K/min).

For semi-crystalline materials, heating to a temperature between extrapolated end temperature of melting (DSC, ISO 11357, heating rate 10 K/min) can be carried out and the starting point of loss in mass (TGA, ISO 11358, heating rate 10 K/min) can be used.

According to a first aspect of the invention, to be corrugated according to the invention, there needs to be a minimum difference between the total width of the widest peak section and the total width of the narrowest valley section when measuring a given window over the length of the fibre. Considering that the fibre core can have arbitrary width or diameter, a relevant measure is not the absolute difference, but the relative variation of the total width measured over a given window over the length of the fibre with respect to a characteristic, constant width of the fibre.

A method to gauge this quality is by taking a micrograph of the fibre shown in its transverse direction, measuring the distribution of its total cross-sectional width w in radial direction along its longitudinal axis Z, and interpreting this distribution w(Z) as a wave signal. A relevant measure is given by taking the standard deviation a of said signal over a length L (said given window over the length of the fibre) between 5 to 50 times the mean width (w) of the fibre and normalizing it over the minimum value wₘᵢₙ, of said signal within this measurement window. This measure σ/wₘᵢₙ according to this first aspect should exceed a value of 0.1, preferably exceeding a value of 0.2 or even 0.3. For examples how this is done in practice, reference is made to FIG. 11 and the corresponding description.

So preferably said corrugated shape is characterized in that the diameter distribution of the outer surface of the sheath along the longitudinal axis Z in a predetermined window has a normalized standard deviation. The normalized standard deviation is defined as the standard deviation a divided by the minimum value wₘᵢₙ in that diameter distribution in said predetermined window. This normalized standard deviation is preferably at least 0.1, preferably at least 0.2, or even 0.3. Said predetermined window is given as a length along the longitudinal axis Z which is 5-50 times the mean width (w) of said diameter distribution, preferably 10-40 times, most preferably 25 times the mean width (w) of said diameter distribution.

Alternatively speaking the corrugation is characterized in that, over a longitudinal length window of 100 μm of the bi- or multicomponent fibre, the difference in total fibre width in a transverse direction between a widest section and a narrowest section within this length window is at least 5 μm, preferably at least 7 μm.

The corrugations can also be characterized by the amplitude variation in that said reinforcing core has a core radius which is essentially constant along said longitudinal axis, i.e. there is one single core fibre which has a circular cross-section, and wherein the radius of the outer surface of said sheath shows variations along said longitudinal axis around a mean sheath radius, said variations having a sheath variation amplitude, and wherein a relative sheath variation amplitude, defined as said sheath variation amplitude divided by said core radius, is at least 0.3, preferably it is more than 0.3, most preferably it is at least 0.35.

For the case of fibres with a circular cross-section of the core material(s) and the perimeter of that cross-section having a radius r, the mean thickness (t) of the outermost sheath follows the equation:

$$\frac{〈 t 〉}{r} = \frac{1}{\sqrt{{v}_{f}}} - 1$$

Typical values for r range from 1.5 μm to 20 μm. In particular, typical values for r in high-performance structural applications range from 3 μm to 7 μm.

According to yet another characterisation of the corrugation, said corrugated shape is characterised by peak sections of large radius and valley sections of small radius, and wherein, preferably over a longitudinal length window of 1 mm, the mean longitudinal length of peak sections divided by the mean longitudinal length of valley sections, is less than 0.9, preferably less than 0.8. Peak sections and valley sections are defined by determining the average radius along the length window and drawing an axial line along this average radius.

Peak sections are oscillations deviating from that average radius in a direction of larger radii, and valley sections are oscillations deviating from that average radius in a direction of smaller radii.

According to a preferred embodiment, the reinforcing core consists of a single fibre with an essentially circular cross-section, which cross-section is essentially constant along said longitudinal axis. Typically, in this case the diameter of the fibre is in the range of 2-40 μm more preferably in the range of 5-25 μm, most preferably in the range of 6-20 μm.

Preferably, the reinforcing core is a glass fibre or carbon fibre, normally it is a glass fibre, with round cross-section, wherein preferably the glass fibre or carbon fibre is provided with a sizing layer (typically a silane based formulation) for improving adhesion with said second, thermoplastic or thermoset material.

According to a preferred embodiment, the first material is selected from the following group: Inorganic materials, such as mineral materials, e.g. technical glasses (electric glasses (E-glasses, alumino-borosilicate glasses with less than 1% wt alkali oxides); A-glasses (Alkali-lime glasses with little to no boron oxide); AR-glasses; electrical/chemical resistance glasses (E-CR-glasses, alumino-lime silicate glasses with less than 1% wt alkali oxides and with high acid resistance); C-glasses (Alkali-lime glasses with high boron oxide content, also T-glasses); D-glasses (borosilicate glasses with low dielectric constant); R-glasses (alumino silicate glasses without MgO and CaO); S-glasses (alumino silicate glasses without CaO but with high MgO content); M-glasses; or basalt; kaolin; alkaline earth silicate (AES, combination of CaO, MgO, and SiO2); refractory ceramic fibre (RCF, also alumino silicate, ASW); polycrystalline wool (PCW, contains over 70% aluminum oxide); alumina; silicon carbide. But also metallic materials (steel alloys; aluminium alloys; copper alloys, platinum alloys and pure platinum, particularly alloys with rhodium); carbon fibres (polyacrylonitrile-derived fibres (PAN-based fibres), HT, IM, HM, HST, HMS, UHM; mesophase pitch derived fibres (MPP-based fibres), HT, IM, HM, HST, HMS, UHM, glassy carbon).

Or organic materials, such as polymeric materials including aramides (para-aramides; meta-aramides), polyethylenes (PE) (UHMWPE, HMWPE, HDPE, LLDPE, LDPE), polyamides (PA) (PA-6, PA-6.6, PA-11, PA-12), polysulfones (polyethersulfones (PES)), polypropylenes (PP), liquid crystal polymers (LCP) (polyethylene terephtalate copolyesters; copolyamides; polyester-amides; aromatic polyesters)

Preferably, said second, thermoplastic material is selected from the group consisting of polymeric materials with or without filler particles, materials can be selected from the following group: polymers soluble in trichloromethane, tetrachloromethane, or 1-bromonaphtalene such as acrylic polymers (acrylonitrile butadiene styrenes (ABS), acrylonitrile styrene acrylates (ASA), poly iso-butyl methacrylates (PiBMA), poly n-butyl methacrylates (PnBMA), polyethyl methacrylate (PEMA), polymethyl methacrylates (PMMA)), cellulose acetate butyrates (CAB), fluorinated ethylene polypropylenes (FEP), polyamides (PA) such as polyamide 12 (PA-12), polybutadienes, polycarbonates (PC) such as bisphenol-A polycarbonates, polychlorotrifluoroethylene (PCTFE), polyimides such as polyetherimides (PEI), polysulfones such as polyethersulfones (PES), polyethylenes (PE) such as UHMWPE, HMWPE, HDPE, LLDPE, LDPE, polyethylene terephtalates (PET), polyisobutylenes (PiB, butyl rubber), polyisoprenes (PIP), polylactic acides (PLA), polyphenylene oxides (PPO), polyphenylene sulfides (PPS), polypropylenes (PP), atactic PP, isotactic PP, polystyrenes (PS), polysulfones (PSU), polyurethanes (PU), polyvinyl acetates (PVA), polyvinyl butyrals, polyvinyl chlorides (PVC), polymers soluble in bromine, acrylic polymers, polyethyl methacrylates (PEMA), polymethyl methacrylates (PMMA), cellulose acetates (CA), cellulose acetate butyrates (CAThB), nitrocelluloses (cellulose nitrates), polycarbonates (PC), bisphenol-A polycarbonates, polyphenylene oxides (PPO), polyurethanes (PU), polyvinyl acetates (PVA).

Also possible are water-soluble polymers such as polyacrylic acid sodium salts, polyethylene glycols, polymethylacrylic acid sodium salts, polystyrenesulfonic acid sodium salts, dextrans, pullulans.

Also possible are polymers processable in melt phase, these include all those polymers listed under «soluble in trichloromethane, tetrachloro-methane, or 1-bromonaphtalene», «soluble in bromine», and «water-soluble», but further cellophanes, polyamides (PA), PA-6, PA-6.6, PA-11, polyacrylonitriles, polybutylene terephtalates, polyaryletherketones (PAEK), polyetherketones (PEK), polyetheretherketones (PEEK), polyetherketoneketones (PEKK), polyetheretherketoneketones (PEEKK), polyetherketoneetherketoneketones (PEKEKK), polymethacrylonitriles (PMAN), polyoxymethylenes (POM, polyacetals, polymethylene oxides), polytetrafluoroethylenes (PTFE), polyvinyl alcohols (PVOH), polyvinyl butyrals, polyvinylidene chlorides (PVDC), polyvinylidene fluorides (PVDF), liquid crystal polymers (SCP), polyethylene terephtalate copolyesters, copolyamides, polyester-amides, aromatic polyesters, thermoplastic elastomers (TPE), polyamide-based (TPA), copolyester-based (TPC), olefine-based (TPO), styrene-based (TPS), polyurethane-based (TPU), cross-linked rubber-based.

Particle materials (the polymer sheaths may contain nanoparticles as filler materials, with primary particle size (TEM) below 1 μm), can be selected from metallic particles, iron, copper, graphite powder, carbon nanotubes (CNT), single-walled CNT (SWCNT), ceramic particles, silicates, alumina, titania, magnesia.

The second material of the sheath may further comprise additives, in particular colourants, processing aids, residual substances from polymerisation, rheology modifiers, pigments, conductivity additives, impact modifiers, adhesion promoters (e.g. amphiphilic molecules) flame protection agents.

The second material of the sheath may also be a pre-polymerized thermoset polymer or mixture of pre-polymerized thermoset polymers (e.g. applied to the core fibre and cured to an intermediate state which provides stable sheaths which do not coalesce at ambient conditions, but will do so at elevated temperature), including epoxy-based resins and hardeners, polyurethane resins and hardeners, silicone resins and hardeners (addition curing silicones or condensation curing silicones).

The second material of the sheath may also be a mixture of thermoplastic polymers, co-polymers, blended polymers, of a mixture of pre-polymerized thermoset polymers, or of a mixture of thermoplastic and pre-polymerized thermoset polymers.

To allow for optimum processing temperatures in the manufacturing of the composite parts, said degradation temperature, ignition temperature, glass transition temperature, melting temperature or liquidus temperature (preferably any of these) of said first material is preferably at least 10° C., preferably at least 20° C., most preferably at least 50° C. higher than the melting temperature, softening temperature, or flow or glass transition temperature of said second, thermoplastic or pre-polymerized thermoset material.

Normally, the reinforcing core is a single fibre however it can also be a bundle of at most 50 fibres, preferably at most 20 fibres, more preferably at most 10 fibres.

BCF, MCF, and/or combinations thereof as proposed may be processed into textile and/or three-dimensional preforms, particularly into random fibre mats, fleeces, woven textiles, into unidirectional, bi-, or multi-axial non-crimp fabrics, into stitchings, braidings, knittings, or wound preforms.

According to yet another preferred embodiment therefore, the present invention relates to a preferably coherent preform comprising or consisting of fibres according as detailed above, wherein preferably the preform is a woven, knitted, or nonwoven structure.

Furthermore, such a roving, yarn, or textile preform made thereof can contain mixes of different bi- or multicomponent fibres, including mixes with bare or sized reinforcing fibres. This is similar to the concept of commingled yarns, which combine bare or sized reinforcing fibres with thermoplastic fibres intended as the mould material to become the composite matrix. The transverse air permeability of a roving, yarn, or textile is still increased over the case of purely cylindrical fibre arrangements when mixing bi- or multicomponent fibres with different levels of corrugations of their outermost sheaths and/or when mixing them with bare or sized reinforcing fibres.

In short, these fibres may be processed into a multitude of types of fibrous textile preform. which is used in the manufacturing of continuous fibre-reinforced plastics.

Methods of making textile preforms include but are not limited to: weaving; plain weave; twill weave; satin weave; unidirectional woven (weft yarn is a light ancillary yarn used only to keep warp yarns in place, but not intended as actual reinforcement).

Possible are non-crimp fabrics (NCF), where one or more unidirectional layer(s) of yarns or rovings are stitched together, such as uniaxial (unidirectional, UD) NCF; biaxial NCF; triaxial NCF; multiaxial NCF layups.

Braiding is also possible, including direct braiding around a mould to preform the part; continuous braiding of tubular intermediate materials.

Knitting is possible as well as crocheting, 3D-knitting or 3D-weaving, where tailored three-dimensional near-net-shape preforms are made, nonwovens or fleeces, including oriented fleeces; cross-ply fleeces; randomly oriented fleeces.

The present invention furthermore relates to a method for making a composite part, preferably a turbine blade, wind rotor blade, by using fibres as detailed above or by using a preform as just mentioned, wherein the fibres or the preform, respectively, are introduced without additional matrix material into a form, subjected to evacuation and preferably subsequent heating up to a temperature at or above the melting temperature of the second, thermoplastic material,

and compacted and cooled, preferably below the crystallisation or glass transition temperature of the second, thermoplastic material, under formation of said composite part. Such preforms are thus placed into a mould and covered with a sealed vacuum film or vacuum bag. The mould may be pretreated with a chemical release aid or a release film. Prior to the layup of the preform, a layer of gelcoat or a film carrying a thermoplastic material with similar function (scratching resistance, UV protection) may be applied. Before applying the vacuum film, the preform may be covered with a release aid (perforated or semi-permeable film or textile) and a breather fleece or similar vacuum distribution aiding medium. To process the material into a stiff structure, vacuum is pulled from the assembly to extract air and any other gases from the preform. At some point during or after the assembly process, a temperature ramp is applied to the mould, such that the temperature of the BCF/MCF sheaths reaches their liquidus temperature only after the vacuum pressure has reached a satisfactory level. This heating may be performed by heating only the mould or, in addition, by directly heating all fibres or a selection thereof by resistance heating or induction heating (if electrically conductive and/or ferromagnetic). A similar function may be achieved by including layers of conductive and/or ferromagnetic material in the preform layup, e.g. copper-wire or steel-wire mesh. Upon reaching liquidus temperature of the sheath everywhere in the preform, the heating is stopped and the mould and layup assembly may be passively or actively cooled below solidus temperature of the preform (the solidus temperature specifies the temperature below which a material is completely solid).

In the meantime, the pressure difference acting on the vacuum bag assembly has compacted the layup and consolidated the preform. After reaching solidus temperature everywhere in the processed material, vacuum may be removed and the fibre-reinforced composite structure may be demoulded.

In the preferably used vacuum bagging process, following the bagging process, the enclosed lay-up is typically evacuated. This removes gases present in the preform and at the same time exerts pressure onto the lay-up which consolidates the material. The entire setup is then heated either within an oven, an autoclave, or a heated tent, or by use of a heating system integrated into the mould and/or the preform or layup itself. When using thermoplastic matrix materials for the outermost sheath, these eventually become liquid and coalesce. At that point, the heating is stopped and the part is either taken out of the heating system left to cool passively or via an active cooling system implemented in the mould. This cooling solidifies the thermoplastic matrix. As soon as the entire part has become solid, the vacuum can be released, the vacuum bag can be opened and the part is demoulded. When using pre-polymerized thermoset matrix materials for the outermost sheath, the increasing temperature first lowers the viscosity of the resin, which results in a coalescence of the sheaths. As time progresses and the heat accelerates the polymerization and cross-linking of the resin, it cures. As soon as the curing reaction has resulted in a solid part with the desired mechanical properties, the vacuum may be released and the part is cooled and demoulded.

Typical values for vacuum pressure and temperature:

Typical values for vacuum pressure range from 1 mbar absolute to 100 mbar absolute. In particular, vacuum pressures below 50 mbar absolute are desired. For cost reasons, typical vacuum setups do not reach pressures below 10 mbar absolute within the vacuum bag. When processing thermoplastic sheath materials, typical temperatures for melting and consolidation depend on the exact material used. Typical processing windows are based on quantifiable thermal properties according to the type of material used:

Amorphous and micro-crystalline materials:

Heating to temperature between extrapolated end temperature of glass transition (DSC, ISO 11357, heating rate 10 K/min) and the starting point of loss in mass (TGA, ISO 11358, heating rate 10 K/min).

Release of vacuum and demoulding after cooling below extrapolated onset temperature of glass transition (DSC, ISO 11357, cooling rate −10 K/min).

Semi-crystalline materials: Heating to temperature between extrapolated end temperature of melting (DSC, ISO 11357, heating rate 10 K/min) and the starting point of loss in mass (TGA, ISO 11358, heating rate 10 K/min).

Release of vacuum and demoulding after cooling below extrapolated onset temperature of crystallization (DSC, ISO 11357, cooling rate same as actual cooling rate during part production) or below extrapolated onset temperature of glass transition (DSC, ISO 11357, cooling rate same as actual cooling rate during part production).

The present invention furthermore relates to a composite part, preferably in the form of a turbine blade or wind wheel blade, made using fibres as described above, or a preform as mentioned above, preferably by using a method as detailed in the preceding paragraphs. Also the present invention relates to the use of fibres as detailed above or of a preform as mentioned above in a vacuum forming process for making a composite part, for example by using a method as detailed above.

According to a further aspect to the proposed invention, a method used to manufacture these BCF/MCF is presented. It encompasses a process starting with the fiberization of a material (e.g. glass, basalt, polymer) or of a precursor material (e.g. polyacrylonitrile (PAN) precursor for carbon fibre) and ending with the collection of multiple fibres gathered in parallel onto a bobbin. In between the fiberization and the collection of the fibres, standard modification or conversion processes may be applied (e.g. fibre stretching, stabilization and carbonization of PAN), all while keeping individual fibres separated and processing them in parallel. Between these optional processes and the gathering of the single fibres, one or more continuous coating methods are used in-line to apply one or multiple coatings onto the core, the last of them comprising the thermoplastic sheath which is converted into the composite matrix once the fibres are used in part production. A particular example already employed is the melt-spinning of glass fibres, the in-line coating of said fibres with a polymer in solution (in particular, polycarbonate (PC) or polymethyl methacrylate (PMMA) dissolved in trichloromethane), and the in-line drying of said solution on the fibre. The coating can be applied by means of a kiss-roll: the fibres are run over a rotating roll which is partially immersed in a bath containing the polymer solution. Through its rotation, the roll entrains a thin layer of said solution. The fibres only touch the surface on the roll for a brief moment, but during this time they are immersed in the solution film carried by the roll, therefore entraining a coating on themselves upon detaching from the roll. This mechanism is supported by using grooves on the roll, which are designed to ensure a robust coating application, to allow for a higher coating speed, and to keep the fibres separate. These grooves can be of an arbitrary cross-section, but their shape, size, and aspect ratio influence the efficiency of the coating process, i.e. at which speed the desired coating may be applied. The undulations in the sheath thickness may be actively or passively caused by a number of methods: they may be actively imprinted via serrations on the kiss-roll, which run perpendicular to the fibre direction, or via an additional set of serrated finishing rolls which imprint the thickness variations while the sheath is solidifying. Alternatively, the surface tension of the coating liquid used may be adjusted to promote or demote the amplitude of the thickness variations. The rotational speed of the kiss-roll may be varied at high frequency to already cause a variable film thickness on the roll itself as well as to vary the relative speed between the core fibres and the roll, which affects the thickness of the film entrained by the fibre. Finally, an alternative may be to spray the fibres with the coating liquid to promote the formation of droplets on the filaments. This last method may be used to apply the full amount of the desired sheath material or it may be used before or after a coating stage which applies the same material with a constant thickness. Also possible are two roller systems to e.g. imprint the undulations. These systems tend to additionally increase the robustness of the coating process.

More generally speaking therefore, the present invention proposes a method for making a fibre as detailed above, wherein the reinforcing core is coated with said second, thermoplastic material, in that
either the second, thermoplastic material is heated to a temperature above its melting temperature and applied to the surface of the reinforcing core in a continuous process under cooling and solidification of the sheath,
or the second, thermoplastic material is dissolved in a suitable solvent and applied to the surface of the reinforcing core in a continuous process under evaporation of the solvent and formation of the sheath.

For the case of polymer dissolved in solvent, the polymer volume content vₚ within the solution can be in the range from 2% vol to 50% vol, particularly from 5% vol to 25% vol. Advantageously, the dynamic viscosity η is in the range from 1 mPa s to 1 Pa s, measured by rotational rheometry using double-wall Couette geometry. Further preferably, the surface tension γ is in the range from 1 mN/m to 100 mN/m, measured by pendant drop test method. The preferred processing properties for glass inside the bushing if produced in line are as follows: temperatures inside bushing from 1000° C. to 1600° C., measured with thermocouple type «SD welded onto interior surface of bushing. The preferred viscosity of glass melt inside bushing from 10 Pa s to 500 Pa s, particularly from 50 Pa s to 100 Pa s. Other parameters can be chosen as follows: linear fibre drawing velocity V from 1 m/s to 100 m/s, particularly from 5 m/s to 60 m/s, circumferential kiss-roll velocity U from 0.05 m/s to 30 m/s, particularly from 0.1 m/s to 10 m/s, kiss-roll radius R from 5 mm to 500 mm, particularly from 10 mm to 100 mm.

To generate the corrugations, the kiss-roll can be operated in a regime creating instability of the free surface flow over the roll, namely by choosing a combination of fluid properties and process parameters resulting in a high capillary number Ca>0.01 and/or a high Weber number We>1. Furthermore, operation of the kiss-roll drive is possible such that the circumferential velocity of the roll is modulated. In other words, the kiss-roll shall not rotate with a constant velocity, but its velocity shall follow a periodic signal, of which the root-mean-square value is positive. The kiss-roll may also contain circumferential grooves which guide either a monofilament or a small group of fibres during the coating stage. These grooves may exhibit either a corrugated width and/or corrugated depth. The shape of the corrugations preferably fulfils the same or at least similar requirements as are imposed on the shape of the corrugations of the resulting fibres.

In between the kiss-roll coating applicator and the gathering shoe, a pair of finishing rollers exhibiting a corrugated surface may imprint their corrugation onto the fibres. The corrugation may be oriented along the axis of the rollers or at any angle other than 90 degrees, meaning the corrugations shall not form parallel grooves running along the circumference of the rollers. When measured along the circumferential direction of the roller, the shape of the corrugations may fulfil the same requirements as are imposed on the shape of the corrugations of the resulting fibres.

The method used to fabricate BCF/MCF is the only proven process, which successfully produces the desired fibres in a continuous manner. It is easily scalable through parallelization (spinning many fibres in parallel and coating them on the same kiss-roll) and it is highly cost-efficient because of its high throughput when scaled.

The second, thermoplastic material can be applied by using a kiss roll, wherein e.g. by way of adapting the relative speed of rotation of the kiss roll to the speed of the reinforcing core, by way of corrugated surface structuring the contact region of the kiss roll, or both, the corrugated shape can be generated.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows cross sections through possible examples of the proposed fibres;

FIG. 2 shows cross sections through possible examples of the proposed fibres as bi-component (leftmost example) and multicomponent fibres;

FIG. 3 shows axial cuts through different examples of the proposed fibres, the uppermost representation reflecting the prior art bicomponent fibre;

FIG. 4 shows a schematic cut through a vacuum forming device;

FIG. 5 shows, from left to right, the vacuum forming process in a cut through the material;

FIG. 6 shows the device for manufacturing the fibre and the downstream coating with the sheath;

FIG. 7 shows examples of grooves in the kiss roll with arbitrary cross sections;

FIG. 8 shows an example of the kiss roll with 3 different grooves;

FIG. 9 shows an example of additional finishing rollers imprinting the thickness variation in the outermost sheath;

FIG. 10 shows the transformation of the material in the vacuum bagging process with microscopic images;

FIG. 11 shows the corrugation analysis of several fibres a)-c) according to the invention, wherein in each case the uppermost illustrations shows a micrograph of the respective fibre, the illustration right below a black and white conversion thereof, and at the bottom the total fibre width distribution as a function of the Z axis together with the calculated values for the minimum width, the maximum width, the difference between these two, as well as for the mean value, the standard deviation and the normalised standard deviation.

### DESCRIPTION OF PREFERRED EMBODIMENTS

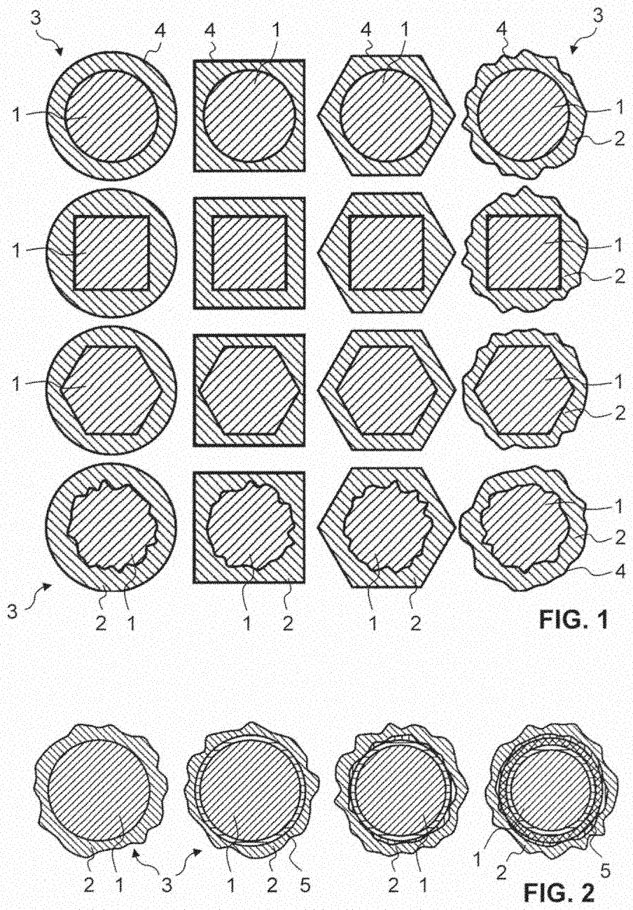

FIG. 1 shows, in a cross-sectional representation, 16 different examples of fibres which are possible according to the present invention. As one can see, the cross-section of the reinforcing core 1 can be circular (uppermost line), it can however also be rectangular (second line), hexagonal (third line) or it can have an irregular shape (bottom line). However, it should be noted that the core can also be a flat fibre, for example of oval shape, cocoon shape, eyebrow shape, or the like. Furthermore, the core can be a hollow fibre. Also, it can be a mixture of different types of cores in a roving or the like.

Also, the shape of the sheath, in a cross-sectional view, can have different forms, as given in the first column, it can be circular, but it can also be essentially rectangular as given in the second column, hexagonal, as given in the third column, or irregular as given in the rightmost column. The sheath is defining the outermost surface 4 of the fibre.

FIG. 2 illustrates that the proposed fibre can be a bicomponent fibre as illustrated in the leftmost representation, consisting of the core 1 and the sheath 2. However, it can also be a multicomponent fibre as given in the other representations. Typically, it is a multicomponent fibre in the sense that, as illustrated in the second representation from the left, the outer surface of the core 1, in particular in case of a glass fibre, is first provided a so-called sizing layer 5, providing for an improved adhesion between the core material and the sheath matrix material, and only then follows the sheath 2 forming the outermost layer of the fibre. Further layers can be present, as illustrated in the 2 rightmost representations, wherein the rightmost representation illustrates an example with the reinforcing core 1 including a sizing layer 5, then followed by 2 additional layers and finally surrounded by the sheath 2. These 2 additional layers can also be made of thermoplastic material and can therefore be considered part of the sheath and to be molten in the manufacturing process to become matrix material. The 2 additional layers can however also be part of the core, so not to be molten in the manufacturing process of the composite part.

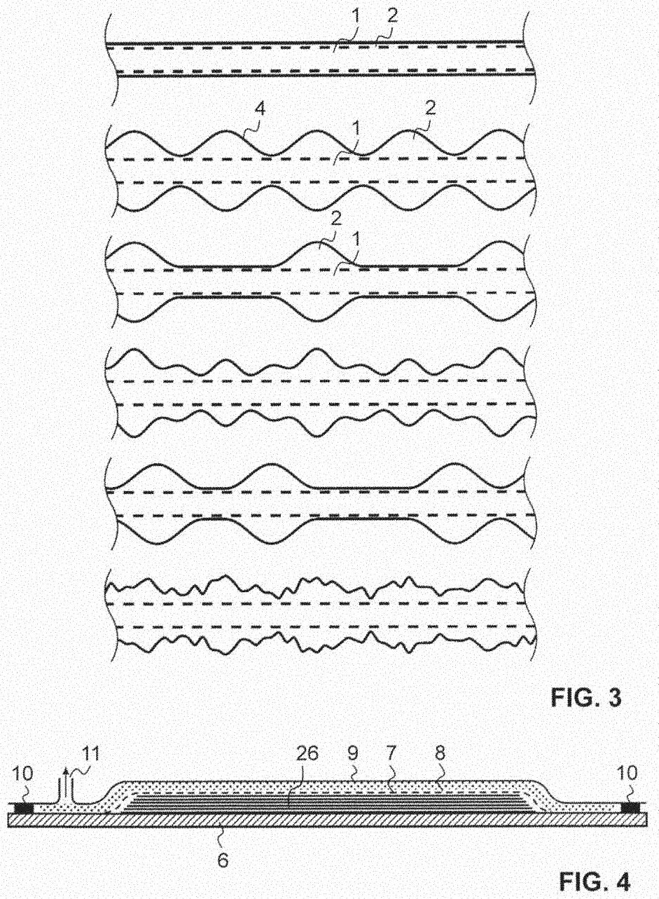

FIG. 3 illustrates axial cuts through fibres. In each case, the core fibre has a constant diameter along the longitudinal axis. However, it is in principle also possible that the core is provided with corrugations. The uppermost representation illustrates the situation according to the state-of-the-art, in this case the sheath along the longitudinal axis of the fibre is not provided with corrugations, but is essentially smooth. The problem with these fibres is that if packed into the form in a transverse direction the deaeration properties are insufficient to allow for the manufacturing of large composite parts.

The second example from the top is provided with a regularly oscillating sheath structure. Such structures may have the problem that due to the symmetry of the outer surface adjacent fibres may nest and not generate sufficient deaeration channels.

This is improved in the third example from the top, where the widening sections are spaced sufficiently so as to avoid nesting without deaeration channels.

The fourth example from the top and the two remaining (lowermost) examples represent irregular corrugation structures, normally due to the production process even if regular structures are imposed for example by kiss roll, rather irregular structures will be produced.

FIG. 4 schematically represents a vacuum bagging layup to convert the proposed fibres, or preforms made thereof, in the form of a preformed stack into a consolidated laminate. The preform 26 is located on top of the mould 6, wherein between the mould and the preform that can be provided a release film (not illustrated). From bottom to top, the preform is followed by a perforated release film 7, then by a vacuum distribution medium 8, and finally by the vacuum bag 9. At the edges sealing tapes 10 are provided for sealing the interior of the vacuum bag, and at least one peripheral point there is provided a vent 11 for deaeration, so to apply the vacuum. Typically, the mould and/or the vacuum bag are provided with means for heating.

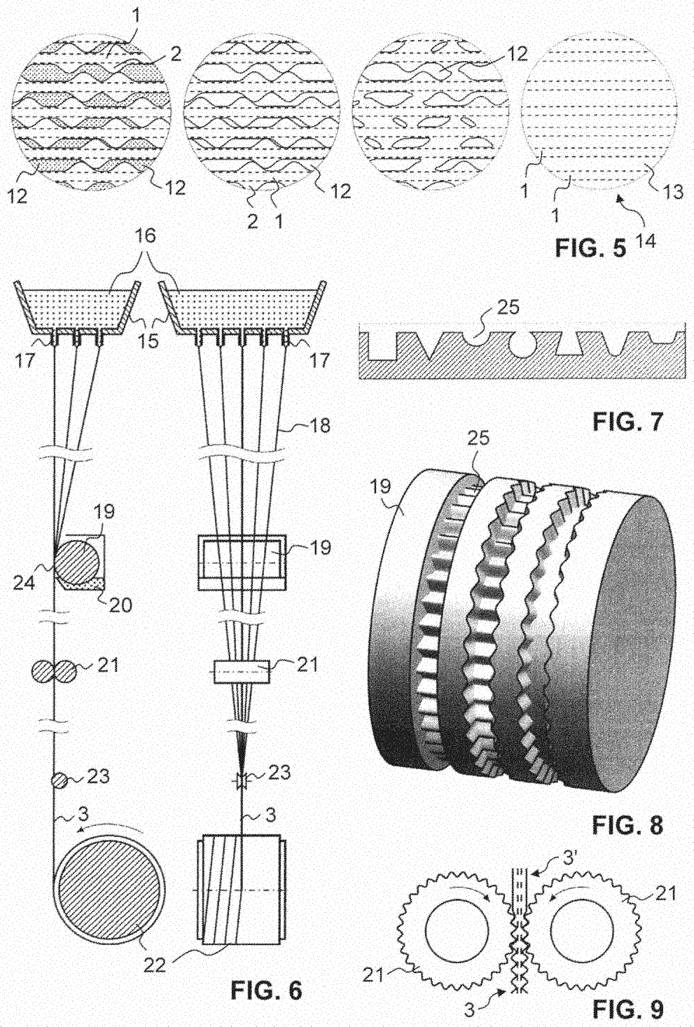

FIG. 5 shows schematically what is taking place, if in such a mould vacuum is applied and then heat. The leftmost illustration shows the fibres arranged essentially parallel to each other, but well spaced due to the corrugations of the sheaths. Between the fibres there remain deaeration channels 12 illustrated with dotted areas. These deaeration channels 12 allow venting, so removal of air in a transverse direction. If the vacuum is applied, as represented in the second representation from the left, air schematically illustrated by the dots in the leftmost representation, is removed from those deaeration channels 12. If then heat is applied while continuing the vacuum, the sheath begins to melt as illustrated in the second representation from the right, and there still remain transverse deaeration channels sufficient to allow for essentially complete deaeration with no encapsulations or entrapments of air in the form of weakening bubbles or the like. At the end the matrix 13 fully surrounds the reinforcing cores 1 and the composite part 14 is formed.

FIG. 6 shows the spinning process from fibre formation to take up on winder including in-line kiss roll coating and optional additional finishing rollers to imprint thickness variation in outermost sheath. In a bath 15 molten glass 16 is provided, and this glass is flowing through an array of glass fibre extrusion nozzles 17. The freshly extruded glass fibre 18 is solidifying downstream of these extrusion nozzles 17 and after solidification is in line coated with the sheath material by way of a kiss roll 19. Kiss roll 19 is immersed partially in bath 20 of dissolved or molten thermoplastic sheath material. In the representation given on the left side the kiss roll rotates in a counter clockwise direction to contact, with the contact surface 24, the fibres passing on the surface of the kiss roll, and due to the rotation the thermoplastic material, either molten or in a solvent, is carried on that surface as entrained from the bath 20. By adapting the transportation speed of the glass fibre relative to the speed of rotation of the kiss roll, i.e. the relative speed of fibre and kiss roll surface, the corrugations can be adapted to the needs. Downstream of the kiss roll, at a position where the thermoplastic material has not yet solidified in case of application of molten thermoplastic material, or at a position where the solvent has not yet fully evaporated in case of application of the solution of thermoplastic material, there can be provided a pair of finishing rolls 21 which shall be explained further below in the context of FIG. 9. In case of extrusion of several parallel strands of glass fibre there can be a collecting roll or gathering shoe 23 downstream of that finishing roll pair, and finally the fibres 3 are collected on the winder 22.

FIG. 7 schematically illustrates a possible cross-sectional shape of the groove 25 in the kiss roll for the purposes described in the summary of the invention.

FIG. 8 schematically illustrates a kiss roll 19 with 3 different grooves for imparting a corrugated topology on the glass fibers passing through these grooves 25 for the coating of the second thermoplastic material on the core fibre.

FIG. 9 illustrates the possibility of using a pair of finishing rolls 21 to generate the corrugated surface on a smooth core fibre. The sheath is applied using the kiss roll in a way generating an essentially smooth surface, leading to the situation as illustrated with 3′. To generate the corrugations the still wet or the still partly soft sheath layer is pressed between the pair of rolls 21 having a corrugated surface topology. This corrugated imprint is then forming the outer surface of the final fibre so leading to the corrugated structure along the longitudinal direction.

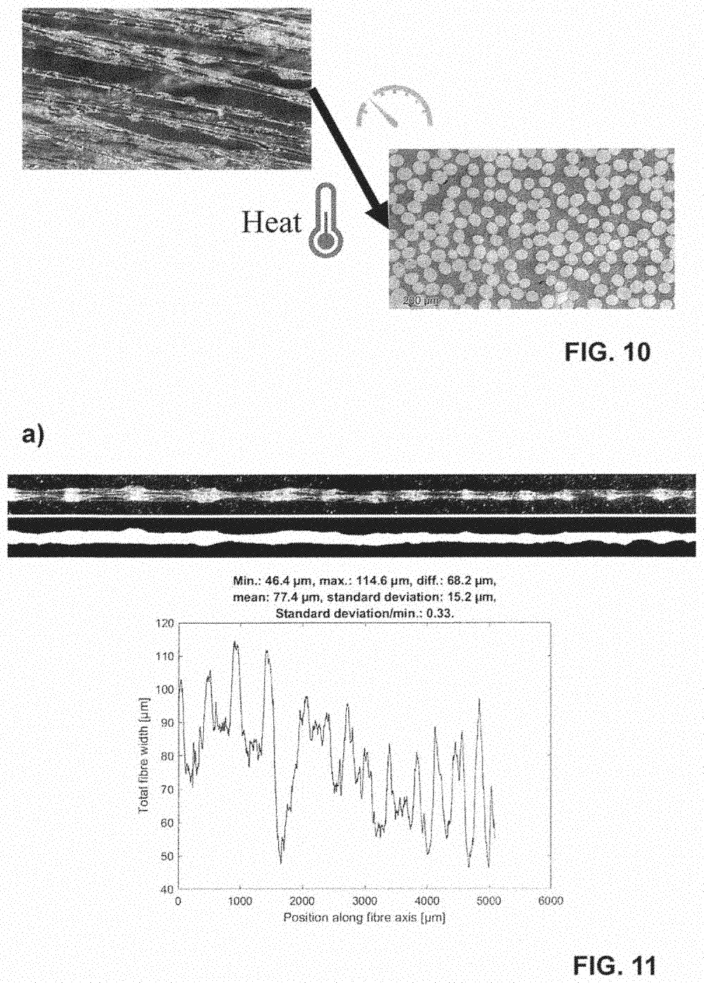

FIG. 10 illustrates with microscopic pictures the transition from the packed glass fibres with corrugated surface (upper left) followed by vacuum and heat treatment and leading to the composite article without any voids of air (lower right). The representations are derived from the specific example detailed below.

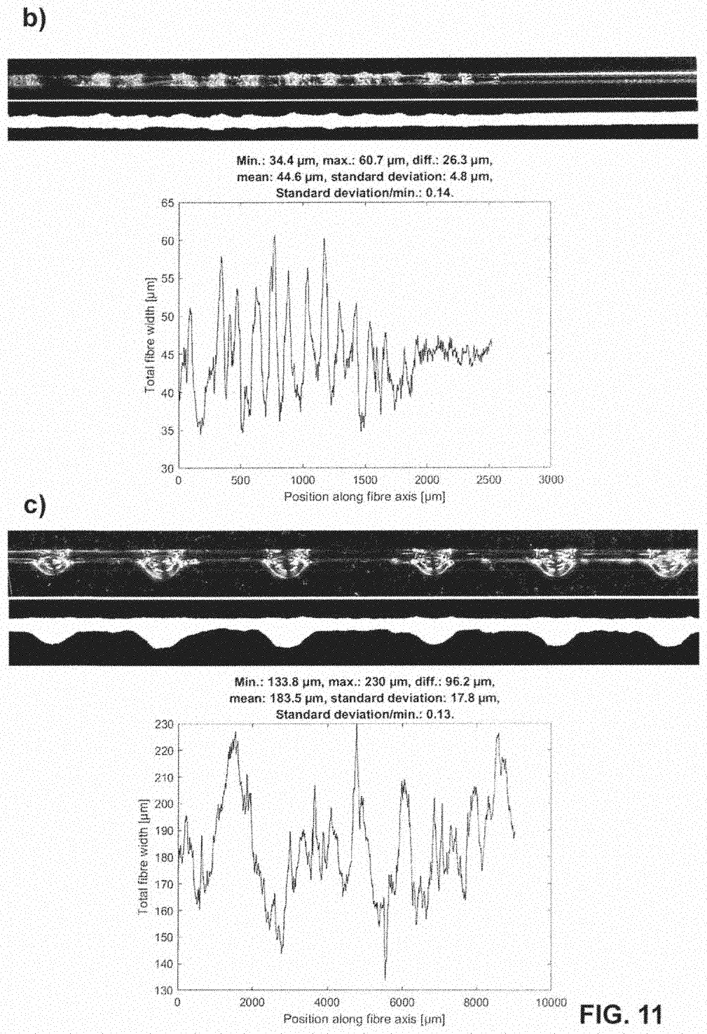

FIG. 11 illustrates micrographs of fibres, which were converted into binary images showing the fibre in white and its surrounding in black. These binary images were measured for the distribution of fibre width along its longitudinal Z axis (array of number of white pixels in every column). The plots show the resulting signals and the relevant statistical measures in the title. It can be seen that all samples exhibit normalized standard deviation values σ/wₘᵢₙ>0.1.

Experimental Section:

### Example for Fabrication of Fibre with Corrugated Coating

The fibres shown in the first two samples a) and b) of FIG. 11 were produced as follows: Alumino-borosilicate glass marbles (Sigmund Lindner SiLibeads, type SL) were heated to 1240° C. inside a bushing consisting of Pt/Rh and embedded in refractory. The bushing was resistance heated (Joule effect) and contained a single spinning nozzle at its lower end. The stream of molten glass exiting the spinning nozzle was drawn downwards by a traversing winder and wound onto a cardboard collet (diameter 136 mm) covered with a polytetrafluoroethylene film. Between the spinning nozzle and the winder, the continuously spun single glass fibre was drawn over a rotating kiss-roll (diameter 130 mm) which was partially immersed in a bath containing a polymer solution. The solution contained 11.5 vol % polycarbonate (Covestro Makrolon 3108) dissolved in trichloromethane (Sigma-Aldrich 319988).

In order to realize a corrugated coating with irregular corrugations along the length of the fibre, the spinning and coating parameters were chosen such that a) the fluid film entrained by the kiss-roll would exhibit a corrugated thickness along the circumference of the kiss-roll; and b) the fluid film entrained by the fibre as it was withdrawn from the liquid film on the kiss-roll would exhibit a corrugated thickness along the length of the fibre, even if the fluid film on the kiss-roll would exhibit a constant thickness along its circumference. This was realized by forcing both the withdrawal of liquid from the bath onto the kiss-roll and the withdrawal of liquid from the kiss-roll onto the fibre to operate in a flow regime which is subject to a Plateau-Rayleigh-type instability. Given the necessary physical conditions, such instabilities occur in dip-coating-like free surface flows, as described in A. G. Gonzalez, J. A. Diez, R. Gratton, D. M. Campana, F. A. Saita, Instability of a viscous liquid coating a cylindrical fibre, Journal of Fluid Mechanics 651 (2010) 117-143. doi: 10.1017/S0022112009993788.

The necessary conditions to force these instabilities can be described by the Capillary number Ca, which is defined as the withdrawal velocity V times to dynamic viscosity n of the coating fluid divided by the surface tension γ of the coating fluid:

$$Ca {=}^{Δ} \frac{V η}{γ}$$

To make it possible for such instabilities to occur, this dimensionless number needs to be close to unity or larger. Depending on the geometry of the substrate, which is withdrawing the liquid, a value greater than 0.01 may already suffice to promote an instability in the flow. The samples illustrated in FIG. 11 were produced using a peripheral roll velocity of 0.3 m/s and fibre velocities of 5.0 m/s (sample a) and 7.9 m/s (sample b), respectively.

The dynamic viscosity of the polymer solution was determined at ambient conditions using oscillatory and continuous rotational rheometry (Anton Paar MCR 502) with a double-wall couette measuring cell (concentric cylinders, DG 26.7). Amplitude sweeps from 0.01% to 100% at a frequency of 10 rad/s showed constant values, indicating that all measurements remained below the limit for linear viscoelasticity. Frequency sweeps from 1 rad/s to 100 rad/s at an amplitude of 100% revealed phase shift angles greater than 85°, indicating that elastic effects are negligible. Flow curves over shear rates of 10 1/s to 1000 1/s revealed constant values, therefore showing Newtonian behaviour of the solution. The solution of 11.5 vol % polycarbonate in trichloromethane was measured to exhibit a dynamic viscosity of 6.70 mPa s.

The surface tension of the polymer solution was determined at ambient conditions using the pendant drop method performed on a Kruss DSA100 drop shape analyzer. Per solution tested, at least 30 droplets were produced by extrusion through a steel cannula with a flat end and an outer diameter of 1.8 mm. Each droplet produced was imaged 31 times. For the solution of 11.5 vol % polycarbonate in trichloromethane, the drop shape analyzer returned a surface tension of 25.8 mN/m.

With the above measurements for the fluid properties of the solution, it can be determined that the coated fibre samples were produced using Capillary numbers as given in the following table:

| | Capillarity of flow | Fibre | Capillarity of flow |
|---|---|---|---|
| Sample | onto the kiss-roll | velocity | onto the fibre |
| a | Ca = 0.078 | 5.0 m/s | Ca = 1.30 |
| b | Ca = 0.078 | 7.9 m/s | Ca = 2.05 |

### Example for Vacuum Bagging Process

A bicomponent monofilament sample was produced by spinning alumino-borosilicate glass (Sigmund Lindner SiLibeads, type SL) at 1240° C. and at a fibre velocity of 4.34 m/s and kiss-roll coating it with a solution of 21 vol % polymethyl methacrylate (Evonik Plexiglas 7N) in trichloromethane (Sigma-Aldrich 319988) at a peripheral roll velocity of 0.3 m/s and a kiss-roll diameter of 130 mm. The resulting sample was measured to contain a core fibre volume fraction (glass volume fraction) of 58.1 vol %. This was measured using thermogravimetric analysis in a Perkin Elmer Pyris 1 TGA (temperature profile: ambient to 600° C. at 10 K/min, dwell at 600° C. for 10 min, then to ambient at −60 K/min) and converting the mass fraction to volume fraction using densities of 2.59 g/cm³ for the glass and 1.19 g/cm³ for the polymer.

The sample was consolidated into a stiff plate using a vacuum bag process. The sample was cut to lengths of ca. 6 cm and placed onto an aluminium plate in a uni-directional fashion (all fibres arranged in parallel). The plate was previously treated with a release agent (Loctite Frekote 700-NC) for easier release after the process. The sample was first covered with a release film (Airtech Wrightlon 5200, ETFE), then with a breather fleece (Airtech Air-weave N4, polyester), and finally with a vacuum film (Airtech Wrightlon 7400). The purpose of the breather fleece was to distribute the vacuum around the periphery of the sample, while the release film hindered the sample from adhering to said breather fleece on the top surface of the arrangement. The vacuum film was sealed to the aluminium plate using sealant tape (“Tacky tape”, Airtech AT 200 Y) to form an airtight vacuum bag assembly. A vacuum port was included next to the sample. A cross-section of this arrangement is depicted in FIG. 4.

The sealed vacuum bag assembly was evacuated to an absolute pressure of 0.06 bar (−0.94 bar relative pressure, measured at the vacuum port) and placed in an oven. The oven was heated to 200° C. (air temperature in the oven) and as soon as this temperature was reached, the oven was turned off and the door opened to cool the sample. As soon as the sample was cold enough to touch by hand, the vacuum was released and the vacuum bag assembly was opened to release the consolidated plate.

To analyse the consolidation quality of the resulting plate, it was cut across the fibre direction and embedded in epoxy (Struers SpeciFix-20). The cured specimen was polished (Struers Abramin lapping machine) and imaged under a digital microscope (Keyence VHX-6000). The micrograph illustrated on the right side in FIG. 10 depicts a representative cross-section of the consolidated plate, demonstrating the high quality achieved (no visible voids/air entrapments).

LIST OF REFERENCE SIGNS

| | |
|---|---|
| 1 | core |
| 2 | sheath |
| 3 | fibre |
| 4 | outer surface of the fibre |
| 5 | sizing layer |
| 6 | mould |
| 7 | release film |
| 8 | vacuum distribution medium |
| | (breather) |
| 9 | vacuum bag |
| 10 | sealing tape |
| 11 | vent for deaeration |
| 12 | transverse deaeration |
| | channels |
| 13 | thermoplastic or thermoset |
| | matrix |
| 14 | composite part |
| 15 | bath of molten glass |
| 16 | molten glass |
| 17 | glass fibre extrusion nozzles |
| 18 | freshly extruded glass fibre |
| 19 | kiss roll |
| 20 | bath of dissolved or molten |
| | thermoplastic sheath material |
| 21 | finishing rolls |
| 22 | drumroll, winder |
| 23 | collecting roll or gathering |
| | shoe |
| 24 | contact surface of kiss roll |
| 25 | groove in 24 of 19 |
| 26 | preform |

1-15. (canceled)

16. A bi- or multicomponent fibre comprising a reinforcing core of a first material and at least one sheath of a second, thermoplastic or pre-polymerized thermoset material, for the manufacturing of composite parts,
the matrix of which composite parts consists of the material of said sheath,
wherein said first material has at least one of a degradation temperature, ignition temperature, glass transition temperature, melting temperature and liquidus temperature which is higher than a melting temperature, flow or glass transition temperature, liquidus temperature or softening temperature of said second, thermoplastic or pre-polymerized thermoset material,
wherein said reinforcing core has a core volume fraction of defined as a volume fraction of the reinforcing core in the bi- or multicomponent fibre, which is in the range of 0.3-0.8,
and wherein along a longitudinal axis of the bi- or multicomponent fibre the outer surface of the sheath has a corrugated shape.

17. The fibre according to claim 16, wherein said corrugated shape has a width distribution of the outer surface of the sheath along the longitudinal axis in a predetermined window which has a normalised standard deviation, defined as the standard deviation a divided by a minimum value wₘᵢₙ in that width distribution in said predetermined window, of at least 0.1 wherein said predetermined window is given as a length along the longitudinal axis which is 5-50 times a mean width (w) of said diameter distribution.

18. The fibre according to claim 16, wherein the corrugation is characterised in that, over a longitudinal length window of 100 μm of the bi- or multicomponent fibre, the difference in total fibre width in a transverse direction between a widest section and a narrowest section within this length window is at least 5 μm.

19. The fibre according to claim 16, wherein said reinforcing core has a core radius r_{f})which is essentially constant along said longitudinal axis
wherein the radius of the outer surface of said sheath shows variations along said longitudinal axis around a mean sheath radius, said variations having a sheath variation amplitude,
and wherein a relative sheath variation amplitude defined as said sheath variation amplitude divided by said core radius r_{f}, is at least 0.3,
and/or wherein said corrugated shape is characterised by peak sections of large radius and valley sections of small radius, and wherein the mean longitudinal length of peak sections divided by the mean longitudinal length of valley sections, is less than 0.9.

20. The fibre according to claim 16, wherein the reinforcing core consists of a single fibre with an essentially circular cross-section, which cross-section is essentially constant along said longitudinal axis.

21. The fibre according to claim 16, wherein the reinforcing core is a glass fibre, ceramic or carbon fibre, with round cross-section.

22. The fibre according to claim 16, wherein said second, thermoplastic or pre-polymerized thermoset material is selected from the group consisting of: polyolefin, polyester, polyamide, polyurethane, polysulfone, acrylic polymers, polycarbonate, polyphenylene oxides, phenol-formaldehyde resins, polyurea resins, melamine resins, epoxy resins, polyurethane resins, silicone resins, and combinations or copolymers thereof.

23. The fibre according to claim 16, wherein said degradation temperature, ignition temperature, glass transition temperature, melting temperature or liquidus temperature of said first material is at least 10° C. higher than the melting temperature, flowing temperature, or softening temperature of said second, thermoplastic or pre-polymerized thermoset material.

24. The fibre according to claim 16, wherein the reinforcing core is a single fibre or a bundle of at most 50 fibres.

25. An essentially coherent preform consisting of fibres according to claim 16.

26. A method for making a fibre according to claim 16, wherein the reinforcing core is coated with said second, thermoplastic or pre-polymerized thermoset material, in that
either the second, thermoplastic or pre-polymerized thermoset material is heated to a temperature above its melting temperature and applied to the surface of the reinforcing core in a continuous process under cooling and solidification of the sheath,
or the second, thermoplastic or pre-polymerized thermoset material is dissolved in a suitable solvent and applied to the surface of the reinforcing core in a continuous process under evaporation of the solvent and formation of the sheath.

27. The method according to claim 26, wherein the second, thermoplastic or pre-polymerized thermoset material is applied by using a kiss roll, wherein by way of adapting the relative speed of rotation of the kiss roll to the speed of the reinforcing core, by way of corrugated surface structuring the contact region of the kiss roll, or both, the corrugated shape is generated.

28. A method for making a composite part, by using fibres according to claim 16, wherein the fibres or the preform, respectively, are
introduced without additional matrix material into a form,
subjected to evacuation and heating up to a temperature at or above the melting temperature, flowing temperature, or softening temperature of the second, thermoplastic or pre-polymerized thermoset material,
and compacted and cooled, under formation of said composite part
or compacted, cured until solidification of the second, thermoset material and under formation of said composite part, and then cooled.

29. A composite part made using fibres according to claim 16.

30. A method of using fibres according to claim 16 in a vacuum forming process for making a composite part.

31. The fibre according to claim 16, wherein along a longitudinal axis of the bi— or multicomponent fibre the outer surface of the sheath has an irregular corrugated shape.

32. The fibre according to claim 16, wherein said corrugated shape has a width distribution of the outer surface of the sheath along the longitudinal axis in a predetermined window with a normalised standard deviation, defined as the standard deviation a divided by the minimum value wₘᵢₙ in that width distribution in said predetermined window, of at least 0.2, or at least 0.3, wherein said predetermined window is given as a length along the longitudinal axis which is 10-40 times the mean width ((w)) of said diameter distribution.

33. The fibre according to claim 16, wherein said corrugated shape is characterised by peak sections of large radius and valley sections of small radius, and wherein, over a longitudinal length window of 1 mm, the mean longitudinal length of peak sections divided by the mean longitudinal length of valley sections, is less than 0.9.

34. The fibre according to claim 16, wherein the reinforcing core consists of a single fibre with an essentially circular cross-section, which cross-section is essentially constant along said longitudinal axis (Z), wherein the diameter of the fibre is in the range of 2-40 μm or in the range of 5-25 μm, or in the range of 6-20 μm.

35. The fibre according to claim 16, wherein the reinforcing core is a glass fibre or carbon fibre with round cross-section, wherein the glass fibre or carbon fibre is provided with a sizing layer for improving adhesion with said second, thermoplastic or thermoset material and/or wherein further the core is a hollow or solid core.

36. The fibre according to claim 16, wherein said degradation temperature, ignition temperature, glass transition temperature, melting temperature or liquidus temperature of said first material is at least 20° C., or at least 50° C. higher than the melting temperature, flowing temperature, or softening temperature of said second, thermoplastic or pre-polymerized thermoset material.

37. The fibre according to claim 16, wherein the reinforcing core is a single fibre or a bundle of at most 20 fibres, or at most 10 fibres.

38. A preform according to claim 25, wherein the preform is a woven, knitted, or nonwoven structure.

39. The method according to claim 28, wherein the composite part is a large energy infrastructure, aerospace, marine or industrial plant infrastructure part.

40. The method according to claim 28, wherein the composite part is a large aeroplane part, a boat hull, a rocket fairing, a pipe, a tank, a silo, or a turbine blade, wind rotor blade.

41. The composite part according to claim 29 in the form of a large energy infrastructure, aerospace, marine or industrial plant infrastructure part.

42. The composite part according to claim 29, in the form of a large aeroplane part, a boat hull, a rocket fairing, a pipe, a tank, a silo, or a turbine blade, wind rotor blade.
